(19) United States
(12) Patent Application Publication
(10) Pub. No.: US 2014/0254661 A1
(43) Pub. Date: Sep. 11, 2014

(54) METHOD AND APPARATUS FOR APPLYING SECONDARY TRANSFORMS ON ENHANCEMENT-LAYER RESIDUALS

(71) Applicant: Samsung Electronics Co., Ltd., Suwon-si (KR)

(72) Inventors: Ankur Saxena, Dallas, TX (US); Felix C. A. Fernandes, Plano, TX (US)

(73) Assignee: Samsung Electronics Co., Ltd., Suwon-si (KR)

(21) Appl. No.: 14/194,246

(22) Filed: Feb. 28, 2014

Related U.S. Application Data
(60) Provisional application No. 61/775,208, filed on Mar. 8, 2013.
(60) Provisional application No. 61/805,404, filed on Mar. 26, 2013.

(51) Int. Cl. H04N 19/625; H04N 19/30

(52) U.S. Cl. CPC H04N 19/00812; H04N 19/00424
USPC 375/240.2

(57) ABSTRACT

A method includes receiving a video bitstream and a flag and interpreting the flag to determine a transform that was used at an encoder. The method also includes, upon a determination that the transform that was used at the encoder includes a secondary transform, applying an inverse secondary transform to the received video bitstream, where the inverse secondary transform corresponds to the secondary transform used at the encoder. The method further includes applying an inverse discrete cosine transform (DCT) to the video bitstream after applying the inverse secondary transform.

### CROSS-REFERENCE TO RELATED APPLICATION AND CLAIM OF PRIORITY

This application claims priority under 35 U.S.C. §119(e) to:
U.S. Provisional Patent Application Ser. No. 61/775,208 filed on Mar. 8, 2013; and
U.S. Provisional Patent Application Ser. No. 61/805,404 filed on Mar. 26, 2013.
   The above-identified provisional patent applications are hereby incorporated by reference in their entirety.

### TECHNICAL FIELD

This application relates generally to a video encoder/decoder (codec) and, more specifically, to a method and an apparatus for applying secondary transforms on enhancement-layer residuals.

### BACKGROUND

Most existing image- and video-coding standards employ block-based transform coding as a tool to efficiently compress an input image or video signals. This includes standards such as JPEG, H.264/AVC, VC-1, and the next generation video codec standard HEVC (High Efficiency Video Coding). Pixel-domain data is transformed to frequency-domain data using a transform process on a block-by-block basis. For typical images, most of the energy is concentrated in low-frequency transform coefficients. Following the transform, a bigger step-size quantizer can be used for higher-frequency transform coefficients in order to compact energy more efficiently and attain better compression. Optimal transforms for each image block to fully de-correlate the transform coefficients are desired.

### SUMMARY

This disclosure provides a method and an apparatus for applying secondary transforms on enhancement-layer residuals.

A method includes receiving a video bitstream and a flag and interpreting the flag to determine a transform that was used at an encoder. The method also includes, upon a determination that the transform that was used at the encoder includes a secondary transform, applying an inverse secondary transform to the received video bitstream, where the inverse secondary transform corresponds to the secondary transform used at the encoder. The method further includes applying an inverse discrete cosine transform (DCT) to the video bitstream after applying the inverse secondary transform.

A decoder includes processing circuitry configured to receive a video bitstream and a flag and to interpret the flag to determine a transform that was used at an encoder. The processing circuitry is also configured to, upon a determination that the transform that was used at the encoder includes a secondary transform, apply an inverse secondary transform to the received video bitstream, where the inverse secondary transform corresponds to the secondary transform used at the encoder. The processing circuitry is further configured to apply an inverse DCT to the video bitstream after applying the inverse secondary transform.

A non-transitory computer readable medium embodying a computer program is provided. The computer program includes computer readable program code for receiving a video bitstream and a flag and interpreting the flag to determine a transform that was used at an encoder. The computer program also includes computer readable program code for, upon a determination that the transform that was used at the encoder includes a secondary transform, applying an inverse secondary transform to the received video bitstream, where the inverse secondary transform corresponds to the secondary transform used at the encoder. The computer program further includes computer readable program code for applying an inverse DCT to the video bitstream after applying the inverse secondary transform.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The temis “include” and “comprise,” as well as derivatives thereof, mean inclusion without limitation. The temi “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an example video encoder according to this disclosure;

FIG. 1B illustrates an example video decoder according to this disclosure;

FIG. 1C illustrates a detailed view of a portion of the example video encoder of FIG. 1A according to this disclosure;

FIG. 2 illustrates an example scalable video encoder according to this disclosure;

FIG. 3 illustrates low-frequency components of an example discrete cosine transform (DCT) transformed block according to this disclosure;

FIG. 4 illustrates an example Inter-Prediction Unit (PU) divided into a plurality of Transform Units according to this disclosure;

FIG. 5 illustrates an example method for implementing a secondary transform at an encoder according to this disclosure; and

FIG. 6 illustrates an example method for implementing a secondary transform at a decoder according to this disclosure.

### DETAILED DESCRIPTION

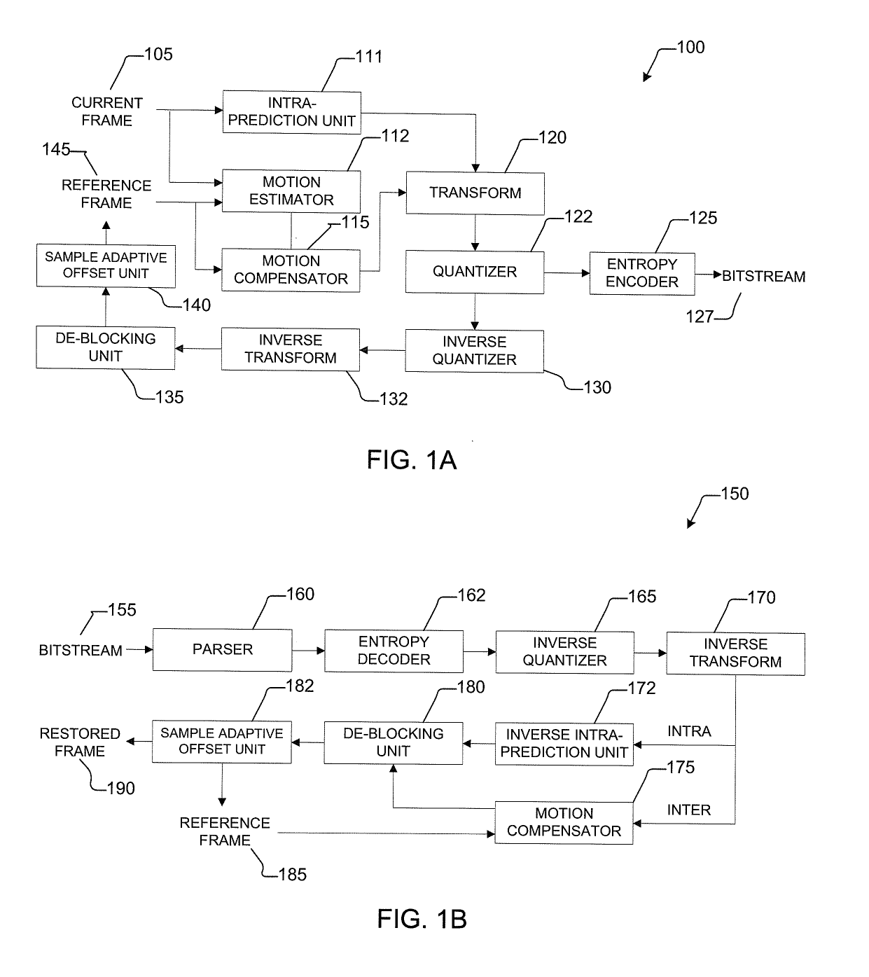

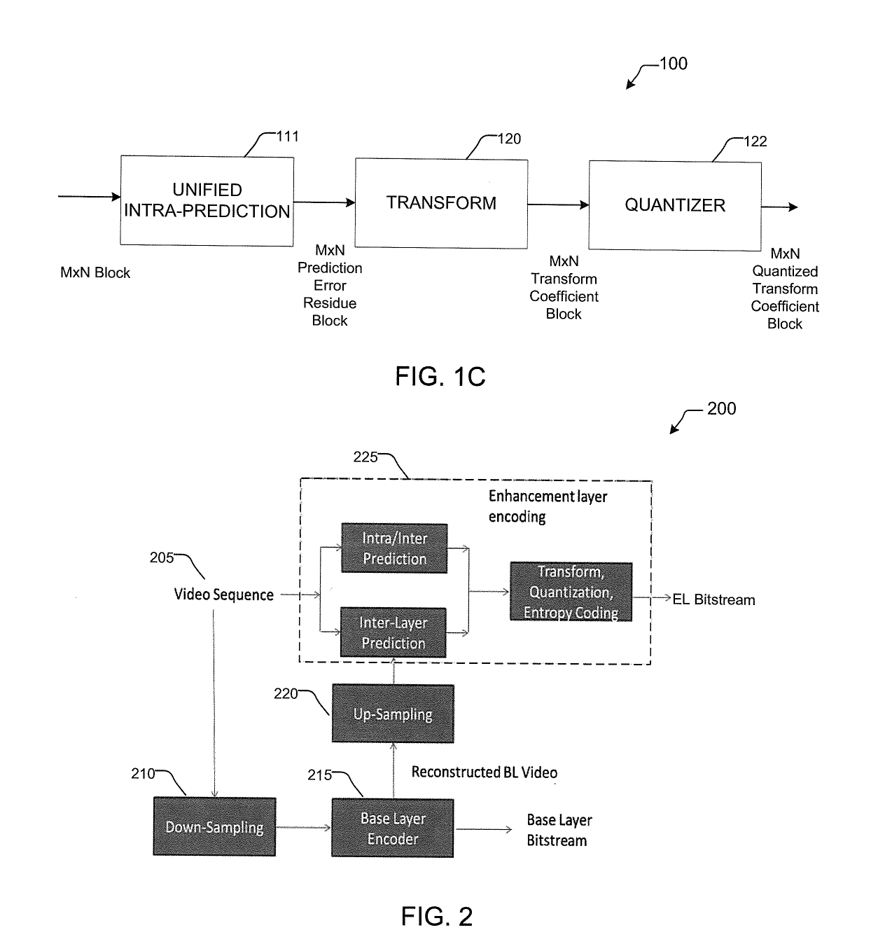

FIGS. 1A through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1A illustrates an example video encoder 100 according to this disclosure. The embodiment of the encoder 100 shown in FIG. 1A is for illustration only. Other embodiments of the encoder 100 could be used without departing from the scope of this disclosure.

As shown in FIG. 1A, the encoder 100 can be based on a coding unit. An intra-prediction unit 111 can perform intra prediction on prediction units of the intra mode in a current frame 105. A motion estimator 112 and a motion compensator 115 can perform inter prediction and motion compensation, respectively, on prediction units of the inter-prediction mode using the current frame 105 and a reference frame 145. Residual values can be generated based on the prediction units output from the intra-prediction unit 111, the motion estimator 112, and the motion compensator 115. The generated residual values can be output as quantized transform coefficients by passing through a transform unit 120 and a quantizer 122.

The quantized transform coefficients can be restored to residual values by passing through an inverse quantizer 130 and an inverse transform unit 132. The restored residual values can be post-processed by passing through a de-blocking unit 135 and a sample adaptive offset unit 140 and output as the reference frame 145. The quantized transform coefficients can be output as a bitstream 127 by passing through an entropy encoder 125.

FIG. 1B illustrates an example video decoder according to this disclosure. The embodiment of the decoder 150 shown in FIG. 1B is for illustration only. Other embodiments of the decoder 150 could be used without departing from the scope of this disclosure.

As shown in FIG. 1B, the decoder 150 can be based on a coding unit. A bitstream 155 can pass through a parser 160 that parses encoded image data to be decoded and encoding information associated with decoding. The encoded image data can be output as inverse-quantized data by passing through an entropy decoder 162 and an inverse quantizer 165 and restored to residual values by passing through an inverse transform unit 170. The residual values can be restored according to rectangular block coding units by being added to an intra-prediction result of an intra-prediction unit 172 or a motion compensation result of a motion compensator 175. The restored coding units can be used for prediction of next coding units or a next frame by passing through a de-blocking unit 180 and a sample adaptive offset unit 182. To perform decoding, components of the image decoder 150 (such as the parser 160, the entropy decoder 162, the inverse quantizer 165, the inverse transform unit 170, the intra prediction unit 172, the motion compensator 175, the de-blocking unit 180, and the sample adaptive offset unit 182) can perform an image decoding process.

Each functional aspect of the encoder 100 and decoder 150 will now be described.

Intra-Prediction (units 111 and 172): Intra-prediction utilizes spatial correlation in each frame to reduce the amount of transmission data necessary to represent a picture. Intra-frame is essentially the first frame to encode but with a reduced amount of compression. Additionally, there can be some intra blocks in an inter frame. Intra-prediction is associated with making predictions within a frame, whereas inter-prediction relates to making predictions between frames.

Motion Estimation (unit 112): A fundamental concept in video compression is to store only incremental changes between frames when inter-prediction is performed. The differences between blocks in two frames can be extracted by a motion estimation tool. Here, a predicted block is reduced to a set of motion vectors and inter-prediction residues.

Motion Compensation (units 115 and 175): Motion compensation can be used to decode an image that is encoded by motion estimation. This reconstruction of an image is performed from received motion vectors and a block in a reference frame.

Transform/Inverse Transform (units 120, 132, and 170): A transform unit can be used to compress an image in inter-frames or intra-frames. One commonly used transform is the Discrete Cosine Transform (DCT). Another transform is the Discrete Sine Transform (DST). Optimally selecting between DST and DCT based on intra-prediction modes can yield substantial compression gains.

Quantization/Inverse Quantization (units 122, 130, and 165): A quantization stage can reduce the amount of information by dividing each transform coefficient by a particular number to reduce the quantity of possible values that each transform coefficient value could have. Because this makes the values fall into a narrower range, this allows entropy coding to express the values more compactly.

De-blocking and Sample adaptive offset units (units 135, 140, and 182): De-blocking can remove encoding artifacts due to block-by-block coding of an image. A de-blocking filter acts on boundaries of image blocks and removes blocking artifacts. A sample adaptive offset unit can minimize ringing artifacts.

In FIGS. 1A and 1B, portions of the encoder 100 and the decoder 150 are illustrated as separate units. However, this disclosure is not limited to the illustrated embodiments. Also, as shown here, the encoder 100 and decoder 150 include several common components. In some embodiments, the encoder 100 and the decoder 150 may be implemented as an integrated unit, and one or more components of an encoder may be used for decoding (or vice versa). Furthermore, each component in the encoder 100 and the decoder 150 could be implemented using any suitable hardware or combination of hardware and software/firmware instructions, and multiple components could be implemented as an integral unit. For instance, one or more components of the encoder 100 or the decoder 150 could be implemented in one or more field programmable gate arrays (FPGAs), application specific integrated circuits (ASICs), microprocessors, microcontrollers, digital signal processors, or a combination thereof.

FIG. 1C illustrates a detailed view of a portion of the example video encoder 100 according to this disclosure. The embodiment shown in FIG. 1C is for illustration only. Other embodiments of the encoder 100 could be used without departing from the scope of this disclosure.

As shown in FIG. 1C, the intra prediction unit 111 (also referred to as a unified intra prediction unit 111) takes a rectangular M×N block of pixels as input and can predict these pixels using reconstructed pixels from blocks already constructed and a known prediction direction. In different implementations, there are different numbers of available intra-prediction modes that have a one-to-one mapping from the intra prediction direction for the various prediction units (such as 17 modes for 4×4; 34 modes for 8×8, 16×16, and 32×32; and 5 modes for 64×64) as specified by the Unified Directional Intra Prediction standard (ITU-T JCTVC-B100_revision02). However, these are merely examples, and the scope of this disclosure is not limit to these examples.

Following the prediction, the transform unit 120 can apply a transform in both the horizontal and vertical directions. The transform (along horizontal and vertical directions) can be either DCT or DST depending on the intra-prediction mode. The transform is followed by the quantizer 122, which reduces the amount of information by dividing each transform coefficient by a particular number to reduce the quantity of possible values that a transform coefficient could have. Because quantization makes the values fall into a narrower range, this allows entropy coding to express the values more compactly and aids in compression.

Scalable video coding is an important component of video processing because it provides scalability of video in various fashions, such as spatial, temporal, and SNR scalability. FIG. 2 illustrates an example scalable video encoder 200 according to this disclosure. The embodiment of the encoder 200 shown in FIG. 2 is for illustration only. Other embodiments of the encoder 200 could be used without departing from the scope of this disclosure. In some embodiments, the encoder 200 may represent the encoder 100 shown in FIGS. 1A and 1C.

As shown in FIG. 2, the encoder 200 receives an input video sequence 205, and a down-sampling block 210 down samples the video sequence 205 to generate a low resolution video sequence, which is coded by a base layer (BL) encoder 215 to generate a BL bitstream. An up-sampling block 220 receives a portion of the BL video, performs up-sampling, and transmits the BL video to an enhancement layer (EL) encoder 225. The EL encoder 225 performs EL layer coding to generate an EL bitstream.

The BL bitstream can be decoded at devices with relatively low processing power (such as mobile phones or tablets) or when network conditions are poor and only BL information is available. When the network quality is good or at devices with relatively greater processing power (such as laptops or televisions), the EL bitstream is also decoded and combined with the decoded BL to produce a higher fidelity reconstruction.

Currently, the Joint Collaborative Team on Video Coding (JCTVC) is standardizing scalable extensions for HEVC (High Efficiency Video Coding) (S-HEVC). For spatial scalability in S-HEVC, a prediction mode known as an Intra_BL mode is used for inter-layer prediction of the enhancement layer from the base layer. Specifically, in the Intra_BL mode, the base layer is up-sampled and used as the prediction for the current block at the enhancement layer. The Intra_BL mode can be useful when traditional temporal coding (inter) or spatial coding (intra) do not provide a low-energy residue. Such a scenario can occur when there is a scene or lightning change or when a new object enters a video sequence. Here, some information about the new object can be obtained from the co-located base layer block but is not present in temporal (inter) or spatial (intra) domains.

In the S-HEVC Test Model, for the Luma component of the Intra_BL prediction residue, the DCT Type 2 transform is applied at block sizes 8, 16 and 32. At size 4, the DST Type 7 transform may be used because the coding efficiencies of DST Type 7 and DCT are almost the same in Scalable-Test Model (SHM) 1.0, but DST is used as the transform for Intra 4×4 Luma Transform Units in the base layer. For the Chroma component of Intra_BL residue, the DCT is used across all block sizes. It is noted that unless otherwise specified, the use of DCT herein refers to DCT Type 2.

Research has shown that different transforms other than DCT Type 2 can provide substantial gains when applied on the Intra_BL block residue. For example, in one test, at sizes 4 to 32, the DCT Type 3 transform and DST Type 3 transform were used in addition to the DCT Type 2 transform. At the encoder, a Rate-Distortion (R-D) search was performed, and one of the following transforms was chosen: DCT Type 2, DCT Type 3, and DST Type 3. The transform choice can be signaled by a flag (such as a flag that can take one of three values for each of the three transforms) to the decoder. At the decoder, the flag can be parsed, and the corresponding inverse transform can be used.

However, the scheme described above requires two additional transform cores at each of sizes 4, 8, 16 and 32. This means eight additional new transform cores are required (two transforms for each of four sizes). Furthermore, additional transform cores (especially larger ones, such as at size 32×32) are extremely expensive to implement in hardware. Thus, to avoid large alternate transforms for inter-prediction residues, a low-complexity transform method that can be applied efficiently on the Intra_BL residues is needed.

To overcome the shortcomings described above and to improve the coding efficiency of SHM (which is the test model for scalable extensions of HEVC), embodiments of this disclosure provide secondary transforms for use with enhancement-layer residuals. The disclosed embodiments also provide fast factorizations for the secondary transforms. In accordance with the disclosed embodiments, a secondary transform can be applied after DCT for Intra_BL and Inter residues. This overcomes the limitations described above by improving inter-layer coding efficiency without significant implementation costs. The secondary transforms disclosed here can be used in the SHM for standardization of the S-HEVC video codec in order to improve compression efficiency.

Low Complexity Secondary Transform

To improve the compression efficiency of an inter-residue block, primary alternate transforms other than a conventional DCT can be applied at block sizes 8×8, 16×16, and 32×32. However, these primary transforms may have the same size as the block size. In general, these alternate transforms at higher block sizes such as 32×32 may have marginal gains that may not justify the enormous cost of supporting an additional 32×32 transform in the hardware.

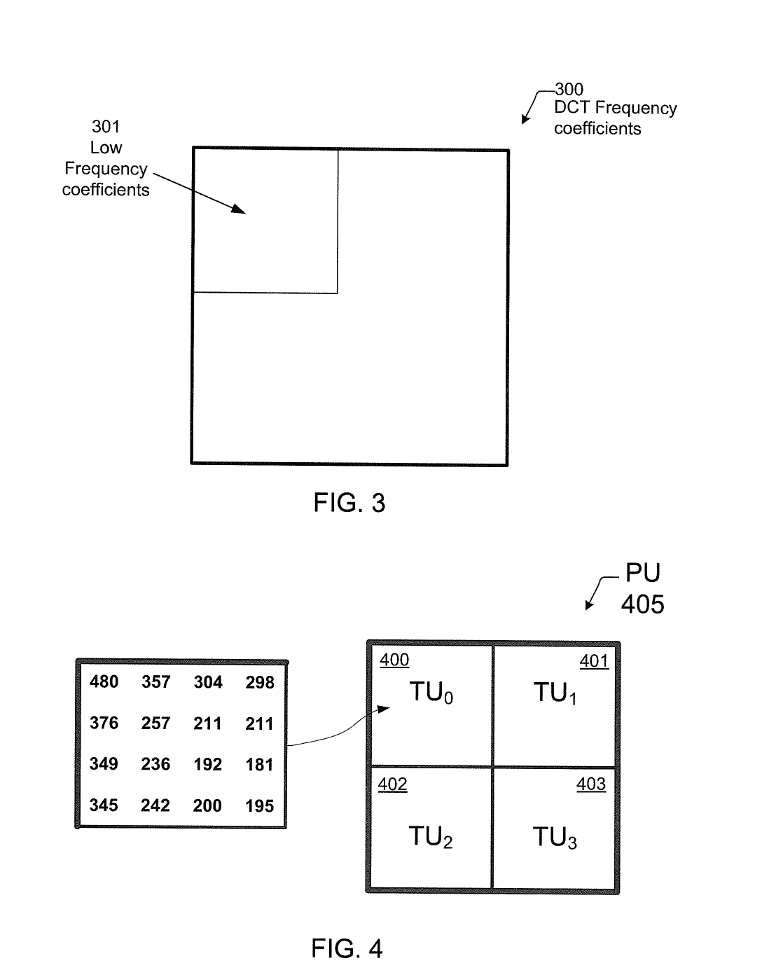

FIG. 3 illustrates low-frequency components of an example DCT transformed block 300 according to this disclosure. The embodiment of the DCT transformed block 300 shown in FIG. 3 is for illustration only. Other embodiments of the DCT transformed block 300 could be used without departing from the scope of this disclosure.

In general, most of the energy of the DCT coefficients of the DCT transformed block 300 is concentrated among the low-frequency coefficients in an upper-left block 301. Accordingly, it may be sufficient to perform operations only on a small fraction of the DCT output, such as only on the upper-left block 301 (which could represent a 4×4 block or an 8×8 block). These operations can be performed using a secondary transform of size 4×4 or 8×8 on the upper-left block 301. Moreover, the same secondary transform derived for a block size such as 8×8 can be applied at higher block sizes (such as 16×16 or 32×32). This re-utilization at higher block sizes is one advantage of embodiments of this disclosure.

Furthermore, the secondary transforms according to this disclosure can be reused across various block sizes, while a primary alternate transform cannot be used. For example, the same 8×8 matrix can be reused as a secondary matrix for the 8×8 lowest frequency band following 16×16 and 32×32 DCT. Advantageously, no additional storage is required at larger blocks (such as 16×16 and higher) for storing any of the new alternate or secondary transforms.

Boundary-Dependent Secondary Transforms for Inter and Intra BL Residue in Enhancement Layer

In some embodiments, an existing secondary transform is extended to be applied on Intra_BL residue. For example, consider FIG. 4, which illustrates an example Inter-Prediction Unit (PU) 405 divided into a plurality of Transform Units TU₀ 400, TU₁ 401, TU₂ 402, and TU₃ 403 according to this disclosure. FIG. 4 shows a possible distribution of energy of residue pixels in the PU 405 and the TUs 400-403. Consider the horizontal transform. In some literature, it has been suggested that the energy of the residues is larger at the boundary and smaller in the center of the PU 405. Thus, for TU₁ 401, a transform with an increasing first basis function (such as DST Type 7) may be better than the DCT as was shown in the context of intra-predicted residues. In some literature, it is proposed to use a “flipped” DST for TU₀ 400 to mimic the behavior of energy of residue pixels in TU₀ 400.

Applying Secondary Transform Via Multiple “Flips”

In some embodiments, instead of using a “flipped” DST, the data can be flipped. Based on this reasoning, a secondary transform can be applied as follows at larger blocks for TU₀ 400, such as 32×32, instead of applying a 32×32 DCT.

At the encoder, the input data is first flipped. For example, for an N-point input vector x with entries xᵢ (i=1 . . . N), define vector y with elements yᵢ=x_{N+1-i}. The DCT of y is determined, and the output is denoted as vector z. A secondary transform is applied on the first K elements of z. Let the output be denoted as w, where the remaining N−K high-frequency elements from z on which the secondary transform was not applied are copied.

Similarly, at the decoder, the input for transform module is defined as vector v, which is a quantized version of w. The following operations can be performed for taking the inverse transform. The inverse secondary transform on the first K elements of v is applied. Let the output be denoted as b, where the N−K high frequency coefficients are identical to that of v. The inverse DCT of b is determined, and the output is denoted as d. The data in d is flipped, such as by defining f with elements fᵢ=d_{N+1-i}. As a result, f represents the reconstructed values for the pixels in x.

For TU₁ 401, the flipping operations may not be required, and a simple DCT followed by a secondary transform can be taken at the encoder. At the decoder, the process takes the inverse secondary transform followed by the inverse DCT.

It is noted that the flipping operation at the encoder and decoder for TU₀ 400 can be expensive in hardware. Thus, the secondary transform can be adapted for these “flip” operations in order to avoid the flipping of data. In one example, assume the N-point input vector x with entries x₁ to x_{N} in TU₀ 400 needs to be transformed appropriately. Let the two-dimensional N×N DCT matrix be denoted as C with elements as follows:

C(i,j), where 1<=(i,j)<=N.

As an example, a normalized (by 128\sqrt{2}) 8×8 DCT is as follows:

| | | | | | | | |
|---|---|---|---|---|---|---|---|
| 64 | 89 | 84 | 75 | 64 | 50 | 35 | 18 |
| 64 | 75 | 35 | −18 | −64 | −89 | −84 | −50 |
| 64 | 50 | −35 | −89 | −64 | 18 | 84 | 75 |
| 64 | 18 | −84 | −50 | 64 | 75 | −35 | −89 |
| 64 | −18 | −84 | 50 | 64 | −75 | −35 | 89 |
| 64 | −50 | −35 | 89 | −64 | −18 | 84 | −75 |
| 64 | −75 | 35 | 18 | −64 | 89 | −84 | 50 |
| 64 | −89 | 84 | −75 | 64 | −50 | 35 | −18 |

with basis vectors along the columns. Note that in DCT, C(i,j)=(−1)^{(j-1)}*C(N+1−i,j). In other words, the odd (first, third, . . . ) basis vectors of DCT are symmetric about the half-way mark. Also, the even (second, fourth, . . . ) basis vectors are symmetric but have opposite signs. This is one property of DCT that can be utilized to appropriately “modulate” the secondary transform.

Extensions for Vertical Secondary Transform

For TU₀ 400 in FIG. 4, in order to take the vertical transform, the data may need to be flipped since energy would be increasing upwards. Alternatively, the coefficients of the secondary transform can be appropriately modulated as described above.

Rate-Distortion Based Secondary Transforms for Intra BL Residue

Research has shown that primary alternative transforms DCT Type 3 and DST Type 3 can be used instead of DCT Type 2. One of the three possible transforms (DCT Type 2, DCT Type 3, and DST Type 3) can be selected via a Rate-Distortion search at the encoder, and the selection can be signaled at the decoder via a flag. At the decoder, the flag can be parsed, and the corresponding inverse transform can be used. However, as explained above, to avoid the significant computational cost, a low-complexity secondary transform for Intra_BL residue can be derived from DCT Type 3 and DST Type 3. This secondary transform achieves similar gains, but at lower complexity.

A description of how a low-complexity secondary transform can be used for Intra_BL residues is now provided. While the derivation and usage of secondary transforms having secondary transform sizes of K*K (K=4 or 8) is shown, this disclosure is not limited thereto, and the derivation and usage can be extended to other block sizes.

Consider a secondary transform of size 4×4. At size 4×4, it is assumed that DCT Type 2 is used as the primary transform. Corresponding to DCT Type 3, a secondary transform is derived as follows. Let C denote the DCT Type 2 transform. DCT Type 3, which is simply the inverse (or transpose) of DCT Type 2, is given by C^{T}. Note that the normalization factors (such as \sqrt{2}) in the definition of the DCTs are ignored, which is a common practice in the art. Also let S denote the DST Type 3 transform.

For an alternate primary transform A and an equivalent secondary transform M, C*M=A. That is, the DCT Type 2 transform followed by M should be mathematically equivalent to A. Therefore, C^{T}*C*M=C^{T}*A, or M=C^{T}*A, since C^{T}C=I for the orthogonal DCT matrix.

If the alternate transform is DCT Type 3 (such as C^{T}), then M=C^{T}*A=C^{T}*C^{T}. For DST Type 3, M would be C^{T}*S.

Derivation for Secondary Transform Corresponding to DCT Type 3

As an example, at size 4×4, DCT Type 2 is given by (basis vectors along columns):

$$\begin{matrix}{C}_{4} = \begin{matrix}0.5000 & 0.6533 & 0.5000 & 0.2706 \\ 0.5000 & 0.2706 & - 0.5000 & - 0.6533 \\ 0.5000 & - 0.2706 & - 0.5000 & 0.6533 \\ 0.5000 & - 0.6533 & 0.5000 & - 0.2706\end{matrix} & ( 1 ) \\ {C}_{4}^{T} = \begin{matrix}0.5000 & 0.5000 & 0.5000 & 0.5000 \\ 0.6533 & 0.2706 & - 0.2706 & - 0.6533 \\ 0.5000 & - 0.5000 & - 0.5000 & 0.5000 \\ 0.2706 & - 0.6533 & 0.6533 & - 0.2706\end{matrix} & ( 2 )\end{matrix}$$

The secondary transform corresponding to DCT Type 3 (M) is given by:

$$\begin{matrix}{M}_{C , 4} = {C}_{4}^{T} * {C}_{4}^{T} \\ = \begin{matrix}0.9619 & - 0.1913 & 0.1913 & 0.0381 \\ 0.1913 & 0.9619 & - 0.0381 & 0.1913 \\ - 0.1913 & 0.0381 & 0.9619 & 0.1913 \\ - 0.0381 & - 0.1913 & - 0.1913 & 0.9619\end{matrix}\end{matrix} \qquad ( 3 )$$

After rounding and shifting by seven bits, the following is determined:

$${M}_{C , 4} = round ( 128 * {C}_{4}^{T} * {C}_{4}^{T} ) \\ {M}_{C , 4}^{T} = \begin{matrix}123 & - 24 & 24 & 5 \\ 24 & 123 & - 5 & 24 \\ - 24 & 5 & 123 & 24 \\ - 5 & - 24 & - 24 & 123\end{matrix} \qquad ( 4 )$$

The above matrix M_{C,4} has basis vectors along columns. To get the basis vectors along rows, M_{C,4} is transposed to obtain:

$${M}_{C , 4}^{T} = \begin{matrix}123 & 24 & - 24 & - 5 \\ - 24 & 123 & 5 & - 24 \\ 24 & - 5 & 123 & - 24 \\ 5 & 24 & 24 & 123\end{matrix} \qquad ( 5 )$$

For a secondary transform of size 8×8, start with a DCT Type 2 transform given by (basis vectors along columns):

$${C}_{8} = \begin{matrix}0.3536 & 0.4904 & 0.4619 & 0.4157 & 0.3536 & 0.2778 & 0.1913 & 0.0975 \\ 0.3536 & 0.4157 & 0.1913 & - 0.0975 & - 0.3536 & - 0.4904 & - 0.4619 & - 0.2778 \\ 0.3536 & 0.2778 & - 0.1913 & - 0.4904 & - 0.3536 & 0.0975 & 0.4619 & 0.4157 \\ 0.3536 & 0.0975 & - 0.4619 & - 0.2778 & 0.3536 & 0.4157 & - 0.1913 & - 0.4904 \\ 0.3536 & - 0.0975 & - 0.4619 & 0.2778 & 0.3536 & - 0.4157 & - 0.1913 & 0.4904 \\ 0.3536 & - 0.2778 & - 0.1913 & 0.4904 & - 0.3536 & - 0.0975 & 0.4619 & - 0.4157 \\ 0.3536 & - 0.4157 & 0.1913 & 0.0975 & - 0.3536 & 0.4904 & - 0.4619 & 0.2778 \\ 0.3536 & - 0.4904 & 0.4619 & - 0.4157 & 0.3536 & - 0.2778 & 0.1913 & - 0.0975\end{matrix} \qquad ( 6 )$$

For a secondary matrix equivalent to DCT Type 3, the following is obtained:

$$\begin{matrix}{M}_{C , 8} = {C}_{8}^{T} * {C}_{8}^{T} \\ = \begin{matrix}0.9340 & - 0.2548 & 0.2020 & - 0.0711 & 0.1092 & - 0.0106 & 0.0634 & 0.0279 \\ 0.3071 & 0.8888 & - 0.2006 & 0.2286 & - 0.0483 & 0.1260 & 0.0173 & 0.0682 \\ - 0.1581 & 0.2918 & 0.9047 & - 0.1073 & 0.2109 & - 0.0014 & 0.1115 & 0.0545 \\ - 0.0303 & - 0.2286 & 0.1718 & 0.9285 & - 0.0223 & 0.2035 & 0.0483 & 0.1050 \\ - 0.0711 & - 0.0106 & - 0.2548 & 0.0279 & 0.9340 & 0.0634 & 0.2020 & 0.1092 \\ - 0.0317 & - 0.0821 & - 0.0120 & - 0.2553 & - 0.1200 & 0.9182 & 0.1568 & 0.2120 \\ - 0.0341 & - 0.0160 & - 0.0764 & - 0.0187 & - 0.2313 & - 0.2566 & 0.8901 & 0.2841 \\ - 0.0120 & - 00243 & - 0.0079 & - 0.0532 & - 0.0215 & - 0.1723 & - 0.3510 & 0.9182\end{matrix}\end{matrix} \qquad ( 7 )$$

Rounding and shifting by seven bits yields:

$$\begin{matrix}{M}_{C , 8} = round ( {C}_{8}^{T} * {C}_{8}^{T} * 128 ) \\ {M}_{C , 8} = \begin{matrix}120 & - 33 & 26 & - 9 & 14 & - 1 & 8 & 4 \\ 39 & 114 & - 26 & 29 & - 6 & 16 & 2 & 9 \\ - 20 & 37 & 116 & - 14 & 27 & 0 & 14 & 7 \\ - 4 & - 29 & 22 & 119 & - 3 & 26 & 6 & 13 \\ - 9 & - 1 & - 33 & 4 & 120 & 8 & 26 & 14 \\ - 4 & - 11 & - 2 & - 33 & - 15 & 118 & 20 & 27 \\ - 4 & - 2 & - 10 & - 2 & - 30 & - 33 & 114 & 36 \\ - 2 & - 3 & - 1 & - 7 & - 3 & - 22 & - 45 & 118\end{matrix} & ( 8 ) \\ {M}_{C , 8}^{T} = \begin{matrix}120 & 39 & - 20 & - 4 & - 9 & - 4 & - 4 & - 2 \\ - 33 & 114 & 37 & - 29 & - 1 & - 11 & - 2 & - 3 \\ 26 & - 26 & 116 & 22 & - 33 & - 2 & - 10 & - 1 \\ - 9 & 29 & - 14 & 119 & 4 & - 33 & - 2 & - 7 \\ 14 & - 6 & 27 & - 3 & 120 & - 15 & - 30 & - 3 \\ - 1 & 16 & 0 & 26 & 8 & 118 & - 33 & - 22 \\ 8 & 2 & 14 & 6 & 26 & 20 & 114 & - 45 \\ 4 & 9 & 7 & 13 & 14 & 27 & 36 & 118\end{matrix} & ( 9 )\end{matrix}$$

Note that M_{C,4} and M_{C,8} are low-complexity secondary transforms that provide similar gains on applying to Intra_BL residue, but at considerably lower complexity, as compared to applying DCT Type 3 as an alternate primary transform.

Derivation of Secondary Transform Corresponding to DST Type 3

The DCT Type 2 matrix at size four is:

$${C}_{4} = \begin{matrix}0.5000 & 0.6533 & 0.5000 & 0.2706 \\ 0.5000 & 0.2706 & - 0.5000 & - 0.6533 \\ 0.5000 & - 0.2706 & - 0.5000 & 0.6533 \\ 0.5000 & - 0.6533 & 0.5000 & - 0.2706\end{matrix} \qquad ( 10 )$$

The DST Type 3 matrix (with basis vectors along the columns) at size 4×4 is given by:

$${S}_{4} = \begin{matrix}0.2706 & 0.6533 & 0.6533 & 0.2706 \\ 0.5000 & 0.5000 & - 0.5000 & - 0.5000 \\ 0.6533 & - 0.2706 & - 0.2706 & 0.6533 \\ 0.5000 & - 0.5000 & 0.5000 & - 0.5000\end{matrix} \qquad ( 11 )$$

When the DST Type 3 matrix is made into a secondary transform M_{S,4}, the following is obtained:

$$\begin{matrix}{M}_{S , 4} = {( {C}_{4} )}^{T} * {S}_{4} \\ = \begin{matrix}0.9619 & 0.1913 & 0.1913 & - 0.0381 \\ - 0.1913 & 0.9619 & 0.0381 & 0.1913 \\ - 0.1913 & - 0.0381 & 0.9619 & - 0.1913 \\ 0.0381 & - 0.1913 & 0.1913 & 0.9619\end{matrix}\end{matrix} \qquad ( 12 )$$

Rounding and shifting by seven bits yields:

$${M}_{S , 4} = \begin{matrix}123 & 24 & 24 & - 5 \\ - 24 & 123 & 5 & 24 \\ - 24 & - 5 & 123 & - 24 \\ 5 & - 24 & 24 & 123\end{matrix} \qquad ( 13 )$$

where the basis vectors are along the columns. Transposing the matrix to have basis vectors along the rows gives the following:

$${M}_{S , 4} = \begin{matrix}123 & - 24 & - 24 & 5 \\ 24 & 123 & - 5 & - 24 \\ 24 & 5 & 123 & 24 \\ - 5 & 24 & - 24 & 123\end{matrix} \qquad ( 14 )$$

For a secondary transform of size 8×8, a DCT Type 2 transform is given by:

$${C}_{8} = \begin{matrix}0.3536 & 0.4904 & 0.4619 & 0.4157 & 0.3536 & 0.2778 & 0.1913 & 0.0975 \\ 0.3536 & 0.4157 & 0.1913 & - 0.0975 & - 0.3536 & - 0.4904 & - 0.4619 & - 0.2778 \\ 0.3536 & 0.2778 & - 0.1913 & - 0.4904 & - 0.3536 & 0.0975 & 0.4619 & 0.4157 \\ 0.3536 & 0.0975 & - 0.4619 & - 0.2778 & 0.3536 & 0.4157 & - 0.1913 & - 0.4904 \\ 0.3536 & - 0.0975 & - 0.4619 & 0.2778 & 0.3536 & - 0.4157 & - 0.1913 & 0.4904 \\ 0.3536 & - 0.2778 & - 0.1913 & 0.4904 & - 0.3536 & - 0.0975 & 0.4619 & - 0.4157 \\ 0.3536 & - 0.4157 & 0.1913 & 0.0975 & - 0.3536 & 0.4904 & - 0.4619 & 0.2778 \\ 0.3536 & - 0.4904 & 0.4619 & - 0.4157 & 0.3536 & - 0.2778 & 0.1913 & - 0.0975\end{matrix} \qquad ( 15 )$$

A DST Type 3 transform at size 8×8 is given by:

$${S}_{8} = \begin{matrix}0.0975 & 0.2778 & 0.4157 & 0.4904 & 0.4904 & 0.4157 & 0.2778 & 0.0975 \\ 0.1913 & 0.4619 & 0.4619 & 0.1913 & - 0.1913 & - 0.4619 & - 0.4619 & - 0.1913 \\ 0.2778 & 0.4904 & 0.0975 & - 0.4157 & - 0.4157 & 0.0975 & 0.4904 & 0.2778 \\ 0.3536 & 0.3536 & - 0.3536 & - 0.3536 & 0.3536 & 0.3536 & - 0.3536 & - 0.3536 \\ 0.4157 & 0.0975 & - 0.4904 & 0.2778 & 0.2778 & - 0.4904 & 0.0975 & 0.4157 \\ 0.4619 & - 0.1913 & - 0.1913 & 0.4619 & - 0.4619 & 0.1913 & 0.1913 & - 0.4619 \\ 0.4904 & - 0.4157 & 0.2778 & - 0.0975 & - 0.0975 & 0.2778 & - 0.4157 & 0.4904 \\ 0.3536 & - 0.3536 & 0.3536 & - 0.3536 & 0.3536 & - 0.3536 & 0.3536 & - 0.3536\end{matrix} \qquad ( 16 )$$

The secondary transform M is given by:

$${M}_{S , 8} = {C}_{8}^{T} * {S}_{8} \\ {M}_{S , 8} = \begin{matrix}0.9340 & 0.2548 & 0.2020 & 0.0711 & 0.1092 & 0.0106 & 0.0634 & - 0.0279 \\ - 0.3071 & 0.8888 & 0.2006 & 0.2286 & 0.0483 & 0.1260 & - 0.0173 & 0.0682 \\ - 0.1581 & - 0.2918 & 0.9047 & 0.1073 & 0.2109 & 0.0014 & 0.1115 & - 0.0545 \\ 0.0303 & - 0.2286 & - 0.1718 & 0.9285 & 0.0223 & 0.2035 & - 0.0483 & 0.1050 \\ - 0.0711 & 0.0406 & - 0.2548 & - 0.0279 & 0.9340 & - 0.0634 & 0.2020 & - 0.1092 \\ 0.0317 & - 0.0821 & 0.0120 & - 0.2553 & 0.1200 & 0.9182 & - 0.1568 & 0.2120 \\ - 0.0341 & 0.0160 & - 0.0764 & 0.0187 & - 0.2313 & 0.2566 & 0.8901 & - 0.2841 \\ 0.0120 & - 0.0243 & 0.0079 & - 0.0532 & 0.0215 & - 0.1723 & 0.3510 & 0.9182\end{matrix} \qquad ( 17 )$$

Rounding and shifting the secondary transform by seven bits yields:

$${M}_{S , 8} = \begin{matrix}120 & 33 & 26 & 9 & 14 & 1 & 8 & - 4 \\ - 39 & 114 & 26 & 29 & 6 & 16 & - 2 & 9 \\ - 20 & - 37 & 116 & 14 & 27 & 0 & 14 & - 7 \\ 4 & - 29 & - 22 & 119 & 3 & 26 & - 6 & 13 \\ - 9 & 1 & - 33 & - 4 & 120 & - 8 & 26 & - 14 \\ 4 & - 11 & 2 & - 33 & 15 & 118 & - 20 & 27 \\ - 4 & 2 & - 10 & 2 & - 30 & 33 & 114 & - 36 \\ 2 & - 3 & 1 & - 7 & 3 & - 22 & 45 & 118\end{matrix} \qquad ( 18 )$$

To have the basis vectors along rows, the matrix M_{S,8} is given by:

$${M}_{S , 8} = \begin{matrix}120 & - 39 & - 20 & 4 & - 9 & 4 & - 4 & 2 \\ 33 & 114 & - 37 & - 29 & 1 & - 11 & 2 & - 3 \\ 26 & 26 & 116 & - 22 & - 33 & 2 & - 10 & 1 \\ 9 & 29 & 14 & 119 & - 4 & - 33 & 2 & - 7 \\ 14 & 6 & 27 & 3 & 120 & 15 & - 30 & 3 \\ 1 & 16 & 0 & 26 & - 8 & 118 & 33 & - 22 \\ 8 & - 2 & 14 & - 6 & 26 & - 20 & 114 & 45 \\ - 4 & 9 & - 7 & 13 & - 14 & 27 & - 36 & 118\end{matrix} \qquad ( 19 )$$

Note that M_{S,4} and M_{S,8} are low-complexity secondary transforms that provide similar gains on applying to Intra_BL residue, but at considerably lower complexity, as compared to applying DST Type 3 as an alternate primary transform.

In the secondary transforms derived using DCT Type 3 and DST Type 3, the coefficients have the same magnitude, and only a few coefficients have alternate signs. This can reduce secondary transform hardware implementation costs. For example, a hardware core for the secondary transform corresponding to DCT Type 3 can be designed. For the secondary transform corresponding to DST Type 3, the same transform core can be used with sign changes for just a few of the transform coefficients.

Research has shown that an 8×8 DCT Type 2 transform can be implemented using 11 multiplications and 29 additions. Therefore, the DCT Type 3 transform, which is a transpose of the DCT Type 2 transform, can also be implemented using 11 multiplications and 29 additions.

The secondary transform M_{C,8}=C₈^{T}*C₈^{T} can be considered as a cascade of two DCTs and therefore can be implemented using 22 multiplications and 58 additions, which is fewer calculations than a full matrix multiplication at size 8×8 (which requires 64 multiplications and 56 additions). Similarly, the secondary transform corresponding to DST Type 3 (which can be obtained by changing signs of some transform coefficients of the previous secondary transform matrix) can also be implemented via 22 multiplications and 58 additions.

It is noted that the derivations of secondary transforms have been shown only for sizes 4 and 8 assuming primary transforms of DCT Type 3 and DST Type 3. However, it will be understood that these derivations can be extended to other transform sizes and other primary transforms.

Rotational Transforms

Some rotational transforms have been derived for Intra residue in the context of HEVC. In fact, the rotational transforms are special cases of secondary transforms and can also be used as secondary transforms for Intra_BL residues. Specifically, the following four rotational transform matrices (with eight-bit precision) and their transposes (which are also rotational matrices) can be used as secondary transforms.

### Rotational Transform 1 Transform Core:

| | | | | | | | |
|---|---|---|---|---|---|---|---|
| 126, | −18, | −16, | 0, | 0, | 0, | 0, | 0 |
| 12, | 119, | −47, | 0, | 0, | 0, | 0, | 0 |
| 21, | 45, | 118, | 0, | 0, | 0, | 0, | 0 |
| 0, | 0, | 0, | 118, | −50, | 2, | 0, | 0 |
| 0, | 0, | 0, | 50, | 117, | −13, | 0, | 0 |
| 0, | 0, | 0, | 4, | 12, | 128, | 0, | 0 |
| 0, | 0, | 0, | 0, | 0, | 0, | 128, | 0 |
| 0, | 0, | 0, | 0, | 0, | 0, | 0, | 128 |

### Rotational Transform 1 Transpose Transform Core:

| | | | | | | | |
|---|---|---|---|---|---|---|---|
| 126, | 12, | 21, | 0, | 0, | 0, | 0, | 0 |
| −18, | 119, | 45, | 0, | 0, | 0, | 0, | 0 |
| −16, | −47, | 118, | 0, | 0, | 0, | 0, | 0 |
| 0, | 0, | 0, | 118, | 50, | 4, | 0, | 0 |
| 0, | 0, | 0, | −50, | 117, | 12, | 0, | 0 |
| 0, | 0, | 0, | 2, | −13, | 128, | 0, | 0 |
| 0, | 0, | 0, | 0, | 0, | 0, | 128, | 0 |
| 0, | 0, | 0, | 0, | 0, | 0, | 0, | 128 |

### Rotational Transform 2 Transform Core:

| | | | | | | | |
|---|---|---|---|---|---|---|---|
| 122, | −31, | −25, | 0, | 0, | 0, | 0, | 0 |
| −38, | −115, | −42, | 0, | 0, | 0, | 0, | 0 |
| −13, | 47, | −119, | 0, | 0, | 0, | 0, | 0 |
| 0, | 0, | 0, | 127, | −14, | −9, | 0, | 0 |
| 0, | 0, | 0, | 11, | 125, | −28, | 0, | 0 |
| 0, | 0, | 0, | 12, | 27, | 125, | 0, | 0 |
| 0, | 0, | 0, | 0, | 0, | 0, | 128, | 0 |
| 0, | 0, | 0, | 0, | 0, | 0, | 0, | 128 |

### Rotational Transform 2 Transpose Transform Core:

| | | | | | | | |
|---|---|---|---|---|---|---|---|
| 122, | −38, | −13, | 0, | 0, | 0, | 0, | 0 |
| −31, | −115, | 47, | 0, | 0, | 0, | 0, | 0 |
| −25, | −42, | −119, | 0, | 0, | 0, | 0, | 0 |
| 0, | 0, | 0, | 127, | 11, | 12, | 0, | 0 |
| 0, | 0, | 0, | −14, | 125, | 27, | 0, | 0 |
| 0, | 0, | 0, | −9, | −28, | 125, | 0, | 0 |
| 0, | 0, | 0, | 0, | 0, | 0, | 128, | 0 |
| 0, | 0, | 0, | 0, | 0, | 0, | 0, | 128 |

### Rotational Transform 3 Transform Core:

| | | | | | | | |
|---|---|---|---|---|---|---|---|
| 122, | −41, | 6, | 0, | 0, | 0, | 0, | 0 |
| 41, | 116, | −35, | 0, | 0, | 0, | 0, | 0 |
| 6, | 36, | 123, | 0, | 0, | 0, | 0, | 0 |
| 0, | 0, | 0, | 126, | −21, | −5, | 0, | 0 |
| 0, | 0, | 0, | −21, | −126, | −14, | 0, | 0 |
| 0, | 0, | 0, | −2, | 15, | −127, | 0, | 0 |
| 0, | 0, | 0, | 0, | 0, | 0, | 128, | 0 |
| 0, | 0, | 0, | 0, | 0, | 0, | 0, | 128 |

### Rotational Transform 3 Transpose Transform Core:

| | | | | | | | |
|---|---|---|---|---|---|---|---|
| 122, | 41, | 6, | 0, | 0, | 0, | 0, | 0 |
| −41, | 116, | 36, | 0, | 0, | 0, | 0, | 0 |
| 6, | −35, | 123, | 0, | 0, | 0, | 0, | 0 |
| 0, | 0, | 0, | 126, | −21, | −2, | 0, | 0 |
| 0, | 0, | 0, | −21, | −126, | 15, | 0, | 0 |
| 0, | 0, | 0, | −5, | −14, | −127, | 0, | 0 |
| 0, | 0, | 0, | 0, | 0, | 0, | 128, | 0 |
| 0, | 0, | 0, | 0, | 0, | 0, | 0, | 128 |

### Rotational Transform 4 Transform Core:

| | | | | | | | |
|---|---|---|---|---|---|---|---|
| 87, | −93, | 12, | 0, | 0, | 0, | 0, | 0 |
| 91, | 79, | −44, | 0, | 0, | 0, | 0, | 0 |
| 25, | 38, | 120, | 0, | 0, | 0, | 0, | 0 |
| 0, | 0, | 0, | 118, | −50, | −5, | 0, | 0 |
| 0, | 0, | 0, | −50, | −118, | −13, | 0, | 0 |
| 0, | 0, | 0, | 1, | 14, | −128, | 0, | 0 |
| 0, | 0, | 0, | 0, | 0, | 0, | 128, | 0 |
| 0, | 0, | 0, | 0, | 0, | 0, | 0, | 128 |

### Rotational Transform 4 Transpose Transform Core:

| | | | | | | | |
|---|---|---|---|---|---|---|---|
| 87, | 91, | 25, | 0, | 0, | 0, | 0, | 0 |
| −93, | 79, | 38, | 0, | 0, | 0, | 0, | 0 |
| 12, | −44, | 120, | 0, | 0, | 0, | 0, | 0 |
| 0, | 0, | 0, | 118, | −50, | 1, | 0, | 0 |
| 0, | 0, | 0, | −50, | −118, | 14, | 0, | 0 |
| 0, | 0, | 0, | −5, | −13, | −128, | 0, | 0 |
| 0, | 0, | 0, | 0, | 0, | 0, | 128, | 0 |
| 0, | 0, | 0, | 0, | 0, | 0, | 0, | 128 |

Due to the structure of rotational transform matrices, there are only twenty non-zero elements at size 8×8. Accordingly, each rotational transform matrix can be implemented using only 20 multiplications and 12 additions, which is much smaller than 64 multiplications and 56 additions required for a full 8×8 matrix. Of the rotational matrices provided above, experimental testing has shown that Rotational Transform 4 Transform Core and Rotational Transform 4 Transpose Transform Core can provide maximum gains when used as secondary transforms.

In addition to or instead of an 8×8 rotational transform, a 4×4 rotational transform can be used. This further reduces the number of required operations. Likewise, the number of operations can be reduced by using a lifting implementation of rotational transforms.

Methods are now described illustrating how a secondary transform can be implemented at block sizes 8, 16, and 32 in a video codec at the encoder and the decoder.

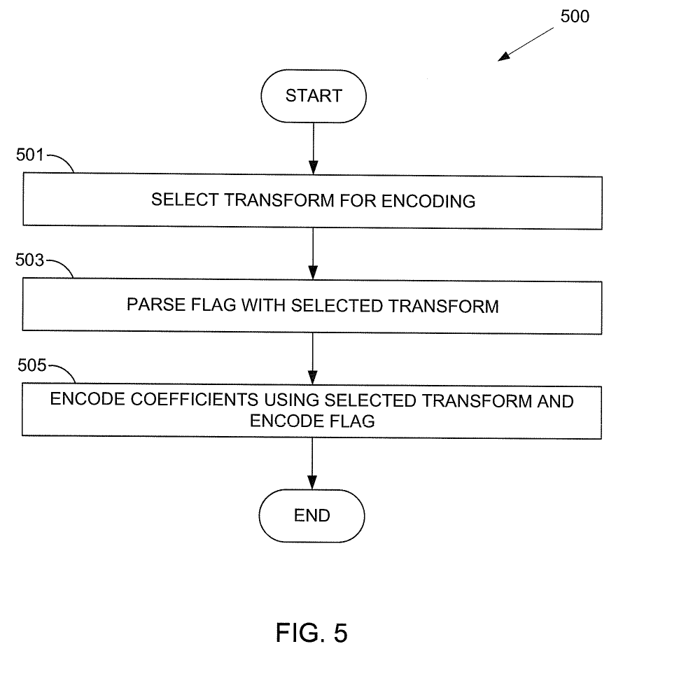

FIG. 5 illustrates an example method 500 for implementing a secondary transform at an encoder according to this disclosure. The encoder here may represent the encoder 100 in FIGS. 1A and 1C or the encoder 200 in FIG. 2. The embodiment of the method 500 shown in FIG. 5 is for illustration only. Other embodiments of the method 500 could be used without departing from the scope of this disclosure.

At operation 501, the encoder selects the transform to be used for encoding. This could include, for example, the encoder selecting from among the following choices of transforms for the transform units in a coding unit (CU) via a Rate-distortion search:
Two-dimensional DCT (order of transforms: Horizontal DCT, Vertical DCT);
Two-dimensional DCT followed by secondary transform M₁ (Order of transforms: {Horizontal DCT, Vertical DCT, Horizontal Secondary Transform, Vertical Secondary Transforms} OR {Horizontal DCT, Vertical DCT, Vertical Secondary Transform, Horizontal Secondary Transform})
Two-dimensional DCT followed by secondary transform M₂ (Order of transforms: {Horizontal DCT, Vertical DCT, Horizontal Secondary Transform, Vertical Secondary Transforms} OR {Horizontal DCT, Vertical DCT, Vertical Secondary Transform, Horizontal Secondary Transform})

In operation 503, based on the transform selected, the encoder parses a flag to identify the selected transform (such as DCT, DCT+M₁, or DCT+M₂). In operation 505, the encoder encodes the coefficients of a video bitstream using the selected transform and encodes the flag with an appropriate value. In some embodiments, it may not be necessary to encode the flag in certain conditions.

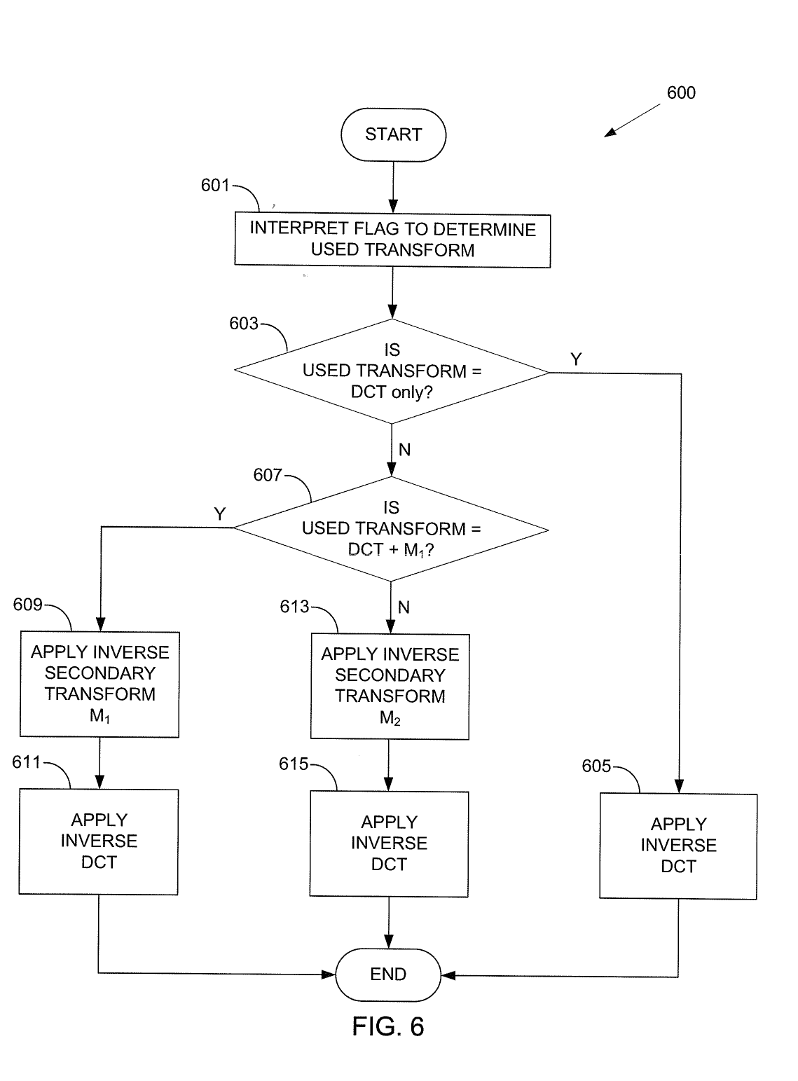

FIG. 6 illustrates an example method 600 for implementing a secondary transform at a decoder according to this disclosure. The decoder may represent the decoder 150 in FIG. 1B. The embodiment of the method 600 shown in FIG. 6 is for illustration only. Other embodiments of the method 600 could be used without departing from the scope of this disclosure.

At operation 601, the decoder receives a flag and a video bitstream and interprets the received flag to determine the transform used at the encoder (such as DCT, DCT+M₁, or DCT+M₂). At operation 603, the decoder determines if the transform used at the encoder is DCT only. If so, in operation 605, the decoder applies an inverse DCT to the received video bitstream. In some embodiments, the order of the transform is {Inverse Vertical DCT, Inverse Horizontal DCT}.

If it is determined in operation 603 that the used transform is not DCT only, in operation 607, the decoder determines if the used transform is DCT+M₁. If so, in operation 609, the decoder applies an inverse secondary transform M₁ to the received video bitstream. The order of the transform may be either {Inverse horizontal secondary transform, inverse vertical secondary transform} or {Inverse vertical secondary transform, inverse horizontal secondary transform}. That is, the order of the transform may be the inverse of what was applied at the encoder in the forward transform path. In operation 611, the decoder applies an inverse DCT to the received video bitstream with an order of the transform of {Inverse Vertical DCT, Inverse Horizontal DCT}.

If it is determined in operation 607 that the used transform is not DCT+M₁, the used transform is DCT+M₂. Accordingly, in operation 613, the decoder applies an inverse secondary transform M₂ to the received video bitstream. The order of the transform may be either {Inverse horizontal secondary transform, inverse vertical secondary transform} or {Inverse vertical secondary transform, inverse horizontal secondary transform}. That is, the order of the transform may be the inverse of what was applied at the encoder in the forward transform path. In operation 615, the decoder applies an inverse DCT to the received video bitstream with an order of the transform of {Inverse Vertical DCT, Inverse Horizontal DCT}.

While the methods 500, 600 are described with only two secondary transform choices (M₁ and M₂), it will be understood that the methods 500, 600 can be extended to additional transform choices, including different transform sizes and block sizes. For example, the secondary transform can be applied at block sizes 16, 32, and so on, and the size of the secondary transform can be K×K (where K=4, 8, etc.). In some embodiments, a rotational transform core can also be used as a secondary transform.

Fast Factorization for Secondary Transforms

Consider the 4×4 secondary transform described above, which is derived from DCT Type 3 (C^{T}), where C denotes DCT Type 2 (M=C^{T}*C^{T}).) In general, the 4×4 matrix M may require 16 multiplications and 12 additions for implementation. In the following embodiment, it will be shown that the actual implementation of M (and hence its transpose M^{T}=C*C) can be performed in only 6 multiplications and 14 additions. This represents a 62.5% reduction in the number of multiplications and only a slight increase (16.67%) in the number of additions. Because implementation complexity, especially from multiplications, can be a significant challenge to transform deployment in image/video coding, this embodiment advantageously adds value by reducing overall complexity.

The derivation of a fast factorization algorithm will now be described. Specifically, consider the matrix Cₜ=C_{T}=C^{T}, which can be represented as follows:

C_{T}(k,n)=c(n)cos(2πn(2k+1)/4N) k,n=0 . . . N−1 (20)

where

$$c ( 0 ) = \frac{1}{\sqrt{N}} and c ( n ) = \sqrt{\frac{2}{N}} ( for n = 1 , … , N - 1 ) . \\ For N = 4 , c ( 0 ) = \frac{1}{2} and c ( n ) = \frac{1}{\sqrt{2}} .$$

The value

$$\frac{1}{\sqrt{2}}$$

can be factored from all terms in the matrix Cₜ. Also, the following is defined:

$$cos ( \frac{2 π k}{4 N} ) = cos ( \frac{2 π k}{16} ) = γ ( k ) .$$

Accordingly, the matrix Cₜ can be written as follows:

$${C}_{t} = [ \begin{matrix}γ ( 2 ) & γ ( 2 ) & γ ( 2 ) & γ ( 2 ) \\ γ ( 1 ) & γ ( 3 ) & γ ( 5 ) & γ ( 7 ) \\ γ ( 2 ) & γ ( 6 ) & γ ( 10 ) & γ ( 14 ) \\ γ ( 3 ) & γ ( 9 ) & γ ( 15 ) & γ ( 21 )\end{matrix} ] \qquad ( 21 )$$

Using the properties of the cosine function, the following holds:

γ(−k)=−γ(k)

γ(16+k)=cos(2π(16+k)/16)=cos(2π+2πk/16)=cos(2πk/16)=γ(k)

γ(8+k)=cos(2π(8+k)/16)=cos(π+2πk/16)=−cos(2πk/16)=−γ(k)

γ(8−k)=cos(2π(8−k)/16)=cos(π−2πk/16)=−cos(−2πk/16)=γ(k) (22)

Thus, after some substitutions and using the above properties for γ(k), the matrix Cₜ can be rewritten as follows:

$${C}_{t} = [ \begin{matrix}γ ( 2 ) & γ ( 2 ) & γ ( 2 ) & γ ( 2 ) \\ γ ( 1 ) & γ ( 3 ) & - γ ( 3 ) & - γ ( 1 ) \\ γ ( 2 ) & - γ ( 2 ) & - γ ( 2 ) & γ ( 2 ) \\ γ ( 3 ) & - γ ( 1 ) & γ ( 1 ) & - γ ( 3 )\end{matrix} ] \qquad ( 23 )$$

Before calculating the various terms in matrix M=Cₜ*Cₜ, the following standard trigonometric identities are noted:

2γ(m)/γ(n)=γ(m+n)+γ(m−n)

2φ(m)φ(n)=γ(m−n)+γ(m+n) (24)

where

$$sin ( \frac{2 π k}{4 N} ) = sin ( \frac{2 π k}{16} ) = φ ( k ) .$$

For the matrix M, element M(1,1) is the inner product of the first row of Cₜ and its first column. The k^{th} row of Cₜ is denoted as Cₜ(k,1:4), and the l^{th} column of Cₜ is denoted as Cₜ(1:4,l). Thus, element M(1,1) is computed as follows:

$$\begin{matrix}M ( 1 , 1 ) = {C}_{t} ( 1 , 1 \text{:} 4 ) * {C}_{t} ( 1 \text{:} 4 , 1 ) \\ = γ ( 2 ) γ ( 2 ) + γ ( 2 ) γ ( 1 ) + γ ( 2 ) γ ( 2 ) + γ ( 2 ) γ ( 3 ) \\ = γ ( 2 ) [ 2 γ ( 2 ) + γ ( 1 ) + γ ( 3 ) ] \\ = γ ( 2 ) [ 2 γ ( 2 ) + 2 γ ( 2 ) γ ( 1 ) ] \\ = 2 γ ( 2 ) γ ( 2 ) [ 1 + γ ( 1 ) ]\end{matrix} \qquad ( 25 )$$

Element M(1, 2)=Ct(1,1:4)*Ct(1:4,2) is computed as follows:

$$\begin{matrix}M ( 1 , 2 ) = {C}_{t} ( 1 , 1 \text{:} 4 ) * {C}_{t} ( 1 \text{:} 4 , 2 ) \\ = γ ( 2 ) γ ( 2 ) + γ ( 2 ) γ ( 3 ) - γ ( 2 ) γ ( 2 ) - γ ( 2 ) γ ( 1 ) \\ = γ ( 2 ) [ γ ( 3 ) - γ ( 1 ) ] \\ = γ ( 2 ) [ - 2 φ ( 2 ) φ ( 1 ) ] \\ = - 2 γ ( 2 ) γ ( 2 ) γ ( 3 )\end{matrix} \\ where \\ φ ( 2 ) = sin ( \frac{2 π ( 2 )}{16} ) = sin ( \frac{π}{4} ) = cos ( \frac{π}{4} ) = γ ( 2 ) \\ and \\ φ ( 1 ) = sin ( \frac{2 π ( 1 )}{16} ) = sin ( \frac{π}{8} ) = cos ( \frac{π}{2} - \frac{π}{8} ) = cos ( \frac{6 π}{16} ) = γ ( 3 ) . \qquad ( 26 )$$

Element M(1, 3) is computed as:

$$\begin{matrix}M ( 1 , 3 ) = {C}_{t} ( 1 , 1 \text{:} 4 ) * {C}_{t} ( 1 \text{:} 4 , 3 ) \\ = γ ( 2 ) [ γ ( 1 ) - γ ( 3 ) ] \\ = 2 γ ( 2 ) γ ( 2 ) γ ( 3 )\end{matrix} \qquad ( 27 )$$

Element M(1, 4) is computed as:

$$\begin{matrix}M ( 1 , 4 ) = {C}_{t} ( 1 , 1 \text{:} 4 ) * {C}_{t} ( 1 \text{:} 4 , 4 ) \\ = γ ( 2 ) [ γ ( 2 ) + γ ( 2 ) - γ ( 1 ) - γ ( 3 ) ] \\ = γ ( 2 ) [ 2 γ ( 2 ) - 2 γ ( 1 ) γ ( 2 ) ] \\ = 2 γ ( 2 ) γ ( 2 ) [ 1 - γ ( 1 ) ]\end{matrix} \qquad ( 28 )$$

Therefore the first row of the matrix M, denoted as M(1, :) can be written as:

M(1,:)=2γ(2)γ(2)[[1+γ(1)−γ(3)γ(3)1−γ(1)]] (29)

### Assume

$$2 γ ( 2 ) γ ( 2 ) = 2 {( cos ( \frac{π}{4} ) )}^{2} = 1.$$

It is defined that γ(1)=a and γ(3)=b. Therefore, M(1, :)=[[1+a−b b 1−a]].

For the other rows of matrix M, the following can be shown. Element M(2, 1) is:

$$\begin{matrix}M ( 2 , 1 ) = {C}_{t} ( 2 , 1 \text{:} 4 ) * {C}_{t} ( 1 \text{:} 4 , 1 ) \\ = γ ( 1 ) γ ( 2 ) + γ ( 3 ) γ ( 1 ) - γ ( 3 ) γ ( 2 ) - γ ( 1 ) γ ( 2 ) \\ = γ ( 2 ) [ γ ( 1 ) - γ ( 3 ) ] \\ = - M ( 1 , 2 ) \\ = b\end{matrix} \qquad ( 30 )$$

### Element M(2, 2) is:

$$\begin{matrix}M ( 2 , 2 ) = {C}_{t} ( 2 , 1 \text{:} 4 ) * {C}_{t} ( 1 \text{:} 4 , 2 ) \\ = γ ( 1 ) γ ( 2 ) + γ ( 3 ) γ ( 3 ) + γ ( 3 ) γ ( 2 ) + γ ( 1 ) γ ( 1 ) \\ = γ ( 2 ) [ γ ( 1 ) + γ ( 3 ) ] + γ ( 3 ) γ ( 3 ) + γ ( 1 ) γ ( 1 ) \\ = γ ( 2 ) [ 2 γ ( 1 ) γ ( 2 ) ] + 1 \\ = 1 + γ ( 1 ) \\ = M ( 1 , 1 ) \\ = 1 + a\end{matrix} \qquad ( 31 )$$

where γ(3)γ(3)+γ(1)γ(1)=γ(3)γ(3)+φ(1)φ(1)=1 since cos²(x)+sin²(x)=1.

### Element M(2, 3) is:

$$\begin{matrix}M ( 2 , 3 ) = {C}_{t} ( 2 , 1 \text{:} 4 ) * {C}_{t} ( 1 \text{:} 4 , 3 ) \\ = γ ( 1 ) γ ( 2 ) - γ ( 3 ) γ ( 3 ) + γ ( 3 ) γ ( 2 ) - γ ( 1 ) γ ( 1 ) \\ = γ ( 2 ) [ γ ( 1 ) + γ ( 3 ) ] - γ ( 3 ) γ ( 3 ) - γ ( 1 ) γ ( 1 ) \\ = γ ( 2 ) [ 2 γ ( 1 ) γ ( 2 ) ] - 1 \\ = - 1 + γ ( 1 ) \\ = - M ( 1 , 4 ) \\ = - ( 1 - a )\end{matrix} \qquad ( 32 )$$

### Element M(2, 4) is:

$$\begin{matrix}M ( 2 , 4 ) = {C}_{t} ( 2 , 1 \text{:} 4 ) * {C}_{t} ( 1 \text{:} 4 , 4 ) \\ = γ ( 1 ) γ ( 2 ) - γ ( 3 ) γ ( 1 ) - γ ( 3 ) γ ( 2 ) + γ ( 1 ) γ ( 3 ) \\ = γ ( 2 ) [ γ ( 1 ) - γ ( 3 ) ] \\ = γ ( 2 ) [ 2 φ ( 2 ) φ ( 1 ) ] - 1 \\ = 2 γ ( 2 ) γ ( 2 ) γ ( 3 ) \\ = γ ( 3 ) \\ = M ( 1 , 3 ) \\ = b\end{matrix} \qquad ( 33 )$$

### Element M(3, 1) is:

$$\begin{matrix}M ( 3 , 1 ) = {C}_{t} ( 3 , 1 \text{:} 4 ) * {C}_{t} ( 1 \text{:} 4 , 1 ) \\ = γ ( 2 ) [ γ ( 2 ) - γ ( 1 ) - γ ( 2 ) + γ ( 3 ) ] \\ = γ ( 2 ) [ γ ( 3 ) - γ ( 1 ) ] \\ = - M ( 1 , 3 ) \\ = - b\end{matrix} \qquad ( 34 )$$

### Element M(3, 2) is:

$$\begin{matrix}M ( 3 , 2 ) = {C}_{t} ( 3 , 1 \text{:} 4 ) * {C}_{t} ( 1 \text{:} 4 , 2 ) \\ = γ ( 2 ) [ γ ( 2 ) - γ ( 3 ) + γ ( 2 ) - γ ( 3 ) ] \\ = γ ( 2 ) [ 2 γ ( 2 ) - γ ( 1 ) - γ ( 3 ) ] \\ = 2 γ ( 2 ) γ ( 2 ) - 2 γ ( 2 ) γ ( 2 ) γ ( 1 ) \\ = 1 - γ ( 1 ) \\ = 1 - a\end{matrix} \qquad ( 35 )$$

### Element M(3, 3) is:

$$\begin{matrix}M ( 3 , 3 ) = {C}_{t} ( 3 , 1 \text{:} 4 ) * {C}_{t} ( 1 \text{:} 4 , 3 ) \\ = γ ( 2 ) [ γ ( 2 ) + γ ( 3 ) + γ ( 2 ) + γ ( 1 ) ] \\ = γ ( 2 ) [ 2 γ ( 2 ) + γ ( 1 ) + γ ( 3 ) ] \\ = 2 γ ( 2 ) γ ( 2 ) + 2 γ ( 2 ) γ ( 2 ) γ ( 1 ) \\ = 1 + γ ( 1 ) \\ = 1 + a\end{matrix} \qquad ( 36 )$$

### Element M(3, 4) is:

$$\begin{matrix}M ( 3 , 4 ) = {C}_{t} ( 3 , 1 \text{:} 4 ) * {C}_{t} ( 1 \text{:} 4 , 4 ) \\ = γ ( 2 ) [ γ ( 2 ) + γ ( 1 ) - γ ( 2 ) - γ ( 3 ) ] \\ = γ ( 2 ) [ γ ( 1 ) - γ ( 3 ) ] \\ = 2 γ ( 2 ) φ ( 2 ) φ ( 1 ) \\ = 2 γ ( 2 ) γ ( 2 ) γ ( 3 ) \\ = γ ( 3 ) \\ = b\end{matrix} \qquad ( 37 )$$

### Element M(4, 1) is:

$$\begin{matrix}M ( 4 , 1 ) = {C}_{t} ( 4 , 1 \text{:} 4 ) * {C}_{t} ( 1 \text{:} 4 , 1 ) \\ = γ ( 3 ) γ ( 2 ) - γ ( 1 ) γ ( 1 ) + γ ( 1 ) γ ( 2 ) - γ ( 3 ) γ ( 3 ) \\ = γ ( 2 ) [ γ ( 1 ) + γ ( 3 ) ] - 1 \\ = γ ( 2 ) [ 2 γ ( 2 ) γ ( 1 ) ] - 1 \\ = γ ( 1 ) - 1 \\ = - ( 1 - a )\end{matrix} \qquad ( 38 )$$

### Element M(4, 2) is:

$$\begin{matrix}M ( 4 , 2 ) = {C}_{t} ( 4 , 1 \text{:} 4 ) * {C}_{t} ( 1 \text{:} 4 , 2 ) \\ = γ ( 3 ) γ ( 2 ) - γ ( 1 ) γ ( 3 ) - γ ( 1 ) γ ( 2 ) + γ ( 3 ) γ ( 1 ) \\ = γ ( 2 ) [ γ ( 3 ) - γ ( 1 ) ] \\ = - b\end{matrix} \qquad ( 39 )$$

### Element M(4, 3) is:

$$\begin{matrix}M ( 4 , 3 ) = {C}_{t} ( 4 , 1 \text{:} 4 ) * {C}_{t} ( 1 \text{:} 4 , 3 ) \\ = γ ( 3 ) γ ( 2 ) + γ ( 1 ) γ ( 3 ) - γ ( 1 ) γ ( 2 ) - γ ( 3 ) γ ( 1 ) \\ = γ ( 2 ) [ γ ( 3 ) - γ ( 1 ) ] \\ = - b\end{matrix} \qquad ( 40 )$$

### Element M(4, 4) is:

$$\begin{matrix}M ( 4 , 4 ) = {C}_{t} ( 4 , 1 \text{:} 4 ) * {C}_{t} ( 1 \text{:} 4 , 4 ) \\ = γ ( 3 ) γ ( 2 ) + γ ( 1 ) γ ( 1 ) + γ ( 1 ) γ ( 2 ) + γ ( 3 ) γ ( 3 ) \\ = γ ( 2 ) [ γ ( 1 ) + γ ( 3 ) ] + 1 \\ = 2 γ ( 2 ) γ ( 2 ) γ ( 1 ) + 1 \\ = 1 + γ ( 1 ) \\ = 1 + a\end{matrix} \qquad ( 41 )$$

Therefore, the matrix M can be written as:

$$M = [ \begin{matrix}1 + a & - b & b & 1 - a \\ b & 1 + a & - ( 1 - a ) & b \\ - b & 1 - a & 1 + a & b \\ - ( 1 - a ) & - b & - b & 1 + a\end{matrix} ] \qquad ( 42 )$$

The operations for a fast factorization method are now described when a four-point input X=[x₀, x₁, x₂, x₃]^{T} is transformed to output Y=[y₀, y₁, y₂, y₃]^{T} via M. Specifically, after rearranging a few terms, the following can be shown:

y₀=(x₀+x₃)+b(x₂−x₁)+a(x₀−x₃)

y₁=b(x₀+x₃)+(x₁−x₂)+a(x₁+x₂)

y₂=b(x₃−x₀)+(x₁+x₂)+a(x₂−x₁)

y₃=(x₃−x₀)+a(x₃+x₀)−b(x₁+x₂)

(43)

Let the following be defined:

c₀=x₀+x₃

c₁=x₂−x₁

c₂=x₀−x₃

c₃=x₂+x₁ (44)

Combining (43) and (44) provides the following:

y₀=c₀+bc₁ac₂

y₁=bc₀−ac₃

y₂=−bc₂+c₃+ac₁

y₃=−c₂+ac₀−bc₃ (45)

The computation of the equations in (45) requires only 8 multiplications and 12 additions. Also, it is noted that a rotation is performed in the computation of y₀ and y₂ and similarly in the computation of y₁ and y₃. Therefore, the number of multiplications can be further reduced by 2 as follows by defining c₄ and c₅:

c₄=a*(c₁+c₂)

c₅=a*(c₀+c₃) (46)

and

y₀=c₀+(b−a)c₁+c₄

y₁=−c₁+(b−a)c₀+c₅

y₂=−(b+a)c₂+c₄+c₃

y₃=−c₂−(b+a)c₃+c₅ (47)

Using the equations in (46) and (47), a transform M can be applied using only 6 multiplications and 14 additions. It is noted that (b−a) and (b+a) are constants and are counted as one entity respectively. As an example, an equivalent 4×4 matrix M_{equiv} can be computed after rounding and shifting by seven bits as follows:

M_{equiv}=round(128*C^{T}*C^{T})

$${M}_{equiv} = [ \begin{matrix}123 & - 24 & 24 & 5 \\ 24 & 123 & - 5 & 24 \\ - 24 & 5 & 123 & 24 \\ - 5 & - 24 & - 24 & 123\end{matrix} ] \qquad ( 48 )$$

The terms in (48) that correspond to (1+a) and (1−a) in (42) are 123 and 5, respectively. Due to bit shifts, (1+a) and (1−a) can be written as 64+59 and 64−59, respectively. Thus, defining a=59 and b=24 gives the following:

c₀=x₀+x₃

c₁=x₂−x₁

c₂=x₀−x₃

c₃=x₂+x₁ (49)

c₄=59*(c₁+c₂)

c₅=59*(c₀+c₃) (50)

and

y₀=c₀<<6+(b−a)c₁+c₄

y₁=−c₁<<6+(b−a)c₀+c₅

y₂=−(b+a)c₂+c₄+c₃<<6

y₃=−c₂<<6−(b+a)c₃+c₅ (51)

or

y₀=c₀<<6−35*c₁+c₄

y₁=−c₁<<6−35*c₀+c₅

y₂=−83*c₂+c₄+c₃<<6

y₃=−c₂<<6−83*c₃+c₅ (52)

It is noted that there are 4 additional shifts due to rounding operations in the computation of the transform, but shifts are generally easy to implement in hardware as compared to multiplications and additions.

The 4×4 secondary matrix M_{S,4} obtained from DST Type 3 can similarly be evaluated using only 6 multiplications and 14 additions, since some of its elements have sign changes as compared to M_{C,4}. The inverse of the matrices M_{C,4} and M_{S,4} can also be computed using 6 multiplications and 14 additions, since they are simply the transpose of M_{C,4} and M_{S,4} respectively, and the operations (for example in a signal-flow-graph) of computation of the transposed matrix can be obtained by simply reversing those for the original matrix. The normalizations (or rounding after bit-shifts) for matrix M_{C,4}, etc., to an integer matrix do not have any effect on the computation, and the transform can still be calculated using 6 multiplications and 14 additions.

The fast factorization algorithm described above can also be used to compute a fast factorization for 8×8 and higher order (e.g., 16×16) secondary transform matrices.

In some literature, there exists a class of scaled DCTs where an 8×8 DCT Type 2 matrix can be computed using 13 multiplications and 29 additions. Out of these 13 multiplications, 8 are at the end, and can be combined with quantization. It is possible to derive a DCT Type 3 matrix similarly with 5 multiplications in the beginning, and 8 at the end. This implies that the inverse of DCT-Type 3 (i.e., DCT Type 2) can have 8 multiplications in the beginning So for the computation of M_{C,8}=C₈*C₈, 8 multiplications at the end of C appearing first in M_{C,8}, and 8 multiplications in the beginning of C₈ appearing later in M_{C,8} can be combined. This can result in a total number of only 5+8+5=18 multiplications, and 29+29=58 additions, which is lower than the 22 multiplications and 58 additions that would be required if two standard DCT computations using Loeffler's algorithm is implemented.

Although the present disclosure has been described with example embodiments, various changes and modifications may be suggested to one skilled in the art. It is intended that the present disclosure encompass such changes and modifications that fall within the scope of the appended claims.

What is claimed is:

1. A method comprising:
receiving a video bitstream and a flag;
interpreting the flag to determine a transform that was used at an encoder;
upon a determination that the transform that was used at the encoder includes a secondary transform, applying an inverse secondary transform to the received video bitstream, the inverse secondary transform corresponding to the secondary transform used at the encoder; and
applying an inverse discrete cosine transform (DCT) to the video bitstream after applying the inverse secondary transform.

2. The method of claim 1, wherein the secondary transform is applied on enhancement-layer residuals of the video bitstream.

3. The method of claim 1, wherein the flag indicates that the transform used at the encoder comprises a DCT primary transform and the secondary transform.

4. The method of claim 3, wherein:
the DCT primary transform is applied to an 8×8 or larger video block; and
the secondary transform is applied to a 4×4 or larger block of low-frequency DCT coefficients in the video block.

5. The method of claim 1, wherein the secondary transform is derived from at least one of: a DCT Type 2 matrix, a DCT Type 3 matrix, and a discrete sine transform (DST) Type 3 matrix.

6. The method of claim 1, wherein the secondary transform is a 4×4 matrix given by:
$${M}_{C , 4} = \begin{matrix}123 & 24 & - 24 & - 5 \\ - 24 & 123 & 5 & - 24 \\ 24 & - 5 & 123 & - 24 \\ 5 & 24 & 24 & 123\end{matrix}$$
$$or$$
$${M}_{S , 4} = \begin{matrix}123 & - 24 & - 24 & 5 \\ 24 & 123 & - 5 & - 24 \\ 24 & 5 & 123 & 24 \\ - 5 & 24 & - 24 & 123\end{matrix} .$$

7. The method of claim 1, wherein the secondary transform is an 8×8 matrix given by:
$${M}_{C , 8} = \begin{matrix}120 & 39 & - 20 & - 4 & - 9 & - 4 & - 4 & - 2 \\ - 33 & 114 & 37 & - 29 & - 1 & - 11 & - 2 & - 3 \\ 26 & - 26 & 116 & 22 & - 33 & - 2 & - 10 & - 1 \\ - 9 & 29 & - 14 & 119 & 4 & - 33 & - 2 & - 7 \\ 14 & - 6 & 27 & - 3 & 120 & - 15 & - 30 & - 3 \\ - 1 & 16 & 0 & 26 & 8 & 118 & - 33 & - 22 \\ 8 & 2 & 14 & 6 & 26 & 20 & 114 & - 45 \\ 4 & 9 & 7 & 13 & 14 & 27 & 36 & 118\end{matrix}$$
$$or$$
$${M}_{S , 8} = \begin{matrix}120 & - 39 & - 20 & 4 & - 9 & 4 & - 4 & 2 \\ 33 & 114 & - 37 & - 29 & 1 & - 11 & 2 & - 3 \\ 26 & 26 & 116 & - 22 & - 33 & 2 & - 10 & 1 \\ 9 & 29 & 14 & 119 & - 4 & - 33 & 2 & - 7 \\ 14 & 6 & 27 & 3 & 120 & 15 & - 30 & 3 \\ 1 & 16 & 0 & 26 & - 8 & 118 & 33 & - 22 \\ 8 & - 2 & 14 & - 6 & 26 & - 20 & 114 & 45 \\ - 4 & 9 & - 7 & 13 & - 14 & 27 & - 36 & 118\end{matrix} .$$

8. The method of claim 1, wherein the secondary transform comprises a rotational transform core applied to Intra_BL residue.

9. A decoder comprising:
processing circuitry configured to:
receive a video bitstream and a flag;
interpret the flag to determine a transform that was used at an encoder;
upon a determination that the transform that was used at the encoder includes a secondary transform, apply an inverse secondary transform to the received video bitstream, the inverse secondary transform corresponding to the secondary transform used at the encoder; and
apply an inverse discrete cosine transform (DCT) to the video bitstream after applying the inverse secondary transform.

10. The decoder of claim 9, wherein the secondary transform is applied on enhancement-layer residuals of the video bitstream.

11. The decoder of claim 9, wherein the flag indicates that the transform used at the encoder comprises a DCT primary transform and the secondary transform.

12. The decoder of claim 11, wherein:
the DCT primary transform is applied to an 8×8 or larger video block; and
the secondary transform is applied to a 4×4 or larger block of low-frequency DCT coefficients in the video block.

13. The decoder of claim 9, wherein the secondary transform is derived from at least one of: a DCT Type 2 matrix, a DCT Type 3 matrix, and a discrete sine transform (DST) Type 3 matrix.

14. The decoder of claim 9, wherein the secondary transform is a 4×4 matrix given by:
$${M}_{C , 4} = \begin{matrix}123 & 24 & - 24 & - 5 \\ - 24 & 123 & 5 & - 24 \\ 24 & - 5 & 123 & - 24 \\ 5 & 24 & 24 & 123\end{matrix}$$
$$or$$
$${M}_{S , 4} = \begin{matrix}123 & - 24 & - 24 & 5 \\ 24 & 123 & - 5 & - 24 \\ 24 & 5 & 123 & 24 \\ - 5 & 24 & - 24 & 123\end{matrix} .$$

15. The decoder of claim 9, wherein the secondary transform is an 8×8 matrix given by:
$${M}_{C , 8} = \begin{matrix}120 & 39 & - 20 & - 4 & - 9 & - 4 & - 4 & - 2 \\ - 33 & 114 & 37 & - 29 & - 1 & - 11 & - 2 & - 3 \\ 26 & - 26 & 116 & 22 & - 33 & - 2 & - 10 & - 1 \\ - 9 & 29 & - 14 & 119 & 4 & - 33 & - 2 & - 7 \\ 14 & - 6 & 27 & - 3 & 120 & - 15 & - 30 & - 3 \\ - 1 & 16 & 0 & 26 & 8 & 118 & - 33 & - 22 \\ 8 & 2 & 14 & 6 & 26 & 20 & 114 & - 45 \\ 4 & 9 & 7 & 13 & 14 & 27 & 36 & 118\end{matrix}$$
$$or$$
$${M}_{S , 8} = \begin{matrix}120 & - 39 & - 20 & 4 & - 9 & 4 & - 4 & 2 \\ 33 & 114 & - 37 & - 29 & 1 & - 11 & 2 & - 3 \\ 26 & 26 & 116 & - 22 & - 33 & 2 & - 10 & 1 \\ 9 & 29 & 14 & 119 & - 4 & - 33 & 2 & - 7 \\ 14 & 6 & 27 & 3 & 120 & 15 & - 30 & 3 \\ 1 & 16 & 0 & 26 & - 8 & 118 & 33 & - 22 \\ 8 & - 2 & 14 & - 6 & 26 & - 20 & 114 & 45 \\ - 4 & 9 & - 7 & 13 & - 14 & 27 & - 36 & 118\end{matrix} .$$

16. The decoder of claim 9, wherein the secondary transform comprises a rotational transform core applied to Intra_BL residue.

17. A non-transitory computer readable medium embodying a computer program, the computer program comprising computer readable program code for:
receiving a video bitstream and a flag;
interpreting the flag to determine a transform that was used at an encoder;
upon a determination that the transform that was used at the encoder includes a secondary transform, applying an inverse secondary transform to the received video bitstream, the inverse secondary transform corresponding to the secondary transform used at the encoder; and
applying an inverse discrete cosine transform (DCT) to the video bitstream after applying the inverse secondary transform.

18. The computer readable medium of claim 17, wherein the secondary transform is applied on enhancement-layer residuals of the video bitstream.

19. The computer readable medium of claim 17, wherein the flag indicates that the transform used at the encoder comprises a DCT primary transform and the secondary transform.

20. The computer readable medium of claim 19, wherein:
the DCT primary transform is applied to an 8×8 or larger video block; and
the secondary transform is applied to a 4×4 or larger block of low-frequency DCT coefficients in the video block.
